(19) United States
(12) Patent Application Publication
(10) Pub. No.: US 2006/0230282 A1
(43) Pub. Date: Oct. 12, 2006

(54) Dynamically managing access permissions

(76) Inventor: Oliver Michael Hausler, Nuremberg (DE)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(21) Appl. No.: 11/398,051

(22) Filed: Apr. 5, 2006

Related U.S. Application Data
(60) Provisional application No. 60/668,674, filed on Apr. 6, 2005.

(51) Int. Cl. H04L 9/00

(52) U.S. Cl. 713/182

(57) ABSTRACT

A method and system with an improved security information is provided to manage permissions of computing objects dynamically. First, an algorithm with the ability to recalculate permissions is created and associated with an object. That algorithm is then invoked every time the object changes, so that modifications of that object's attributes result in changes to the object's access permissions.

### PARTIAL WAIVER OF COPYRIGHT

All of the material in this patent application is subject to copyright protection under the copyright laws of the United States and of other countries. As of the first effective filing date of the present application, this material is protected as unpublished material. However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### CROSS-REFERENCE TO RELATED APPLICATIONS

This non-provisional application is based upon and claims priority to the provisional patent application Ser. No. 60/668,674 with inventor Oliver Michael Hausler and entitled “Method and System for Dynamically Managing Access Permissions” filed Apr. 6, 2005, which is hereby incorporated by reference in its entirety.

### FIELD OF THE INVENTION

The present invention generally relates to computer operating and database systems that manage permissions of computing objects and more particularly to security descriptors that store or refer to executable information related to access control entries.

### BACKGROUND OF THE INVENTION

Permissions provide a way to securely control access to objects that are stored on a computer system. Broadly, each object maintains a list of permissions, which grant certain types of access to specified entities.

When a computing object is created the first time, the procedure, program or entity that creates it takes ownership of that object and receives the permission to edit the object's list of permissions, thus granting further permissions to other entities. The word object is used to denote computing objects which represent unique system resources such as servers, computers, printers, gateways, system events, files, database objects and other software objects (which includes any self-contained item that consists of both data and procedures to manipulate the data), including but not limited to Microsoft Windows Active Directory objects, Microsoft Exchange Store objects, Apple Open Directory objects, Novell eDirectory objects. In addition, at the discretion of the owner or as determined by the operating system, permissions of an object can be inherited by its child objects.

In current versions of the Microsoft Windows operating system, for example, a security descriptor with an access control list is associated with each object. The access control list consists of a list of access control entries, each including a trusted entity and a list of access rights for that entity. When access to an object is requested, the operating system consults the object's security descriptor and performs a search on the access control entries, until it finds one corresponding to the requesting entity. It then matches this access control entry against the requested type of access. Access is only granted, when the access control of the requesting entity is found and permissions match.

By contrast, in Novell's SuSE flavour of the Linux operating system and others, access control entries are first masked to maintain compatibility with the basic permissions model of early UNIX operating systems, and then matched against specific entities in a predetermined order, not in the order they are stored. Further, whereas in the Microsoft Windows operating system every object has its own assigned security descriptor, some Linux distributions recognize assigned security descriptors as well as generic class security descriptors which control access to a specific object type. In addition, the latest Mac OS X operating system also relies on the permissions model of UNIX/Linux operating systems.

Although these methods of granting permission when an access control entry of the requesting entity is found and permission matched are commonly used, they are not without their shortcomings.

One shortcoming is that static access permissions, even in combination with inheritance or other techniques to control access to computing objects as used today, are not completely adequate for some applications due to certain unsolved problems. Also, often it is desirable to store all computing objects of a certain type in the same location. Although it is possible to assign different access permissions to each of those objects individually, such assignment is static and needs to be revised manually from time to time.

For example, suppose a company wants to keep all its customer contact objects in one folder. If that company had several sales persons and wanted to allow every sales person only to be able to access customers of a certain area, the company had to assign access permissions to every single contact object and revise these manually from time to time. To avoid this difficulty, today many companies, assign the same and much broader access rights to all customer contact objects and have the client software filter the objects dependent on the sales person currently using the software. However, assigning this broad access rights exposes significant security risks. Therefore a need exists for managed access permissions, in which a company deploy a security policy that dynamically calculates each customer contact object's permissions, for example dependent on the customer's ZIP Code.

In another example, a company wants to implement a workflow and route forms from one employee to another, dependent on how the form fields were filled in. Workflow data is distributed throughout the workspaces of participants, instead of being located in one convenient location, which is difficult to manage. To avoid having to route the forms into different locations for example by email, as is frequently done today, a need exists for managed access permissions, so all forms can be stored in one convenient location and access rights to the each form change dynamically while the form is filled in.

In another example, a company maintains a support help desk and all incoming support requests are stored in a folder. It is problematic, to manage those support requests in one convenient folder while assigning each support call to an appropriate specialist. However, assigning different access permissions to each specialist is an administrative burden. Consequently, there is a need for dynamically assigning access permissions to a given support specialist based upon key words, the support level, and the state of a support request.

Accordingly, what is needed is a method and system to overcome the problems encountered in the prior art and to enable dynamic creation, modification and/or deletion of access permissions when attributes of an object change.

### SUMMARY OF THE INVENTION

The present invention overcomes the problems with the prior art by providing an improved security descriptor that stores executable information or refers to executable information, and a method on how access control entries are dynamically created, modified or deleted when attributes of an object change. Those dynamically created, modified or deleted access control entries will be referred to as managed access control entries. Further, it allows the owner of an object to specify how permissions of the object depend on other attributes of that object. This is achieved by introducing a new object data type and object, which will be referred to as an instruction control entry. Instruction control entries are stored in a new collection data type and collection, which will be referred to as an instruction control list. Every improved security descriptor stores a plurality of instruction control lists.

An instruction control entry consists of executable instructions represented by an algorithm, rule, policy or similar structure, here referred to as an algorithm. Every time an object is stored, the algorithm reads attributes of that object as input parameters and uses them to output a list of managed access control entries. In addition to the algorithm, an instruction control entry can optionally include helper objects such as pre-set lists of entities or pre-set lists of access rights, which help it to build managed access control entries.

In contrast to prior art, the present invention provides a way to change access permissions of an object dynamically every time that object changes.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention will be apparent from the following detailed description taken in conjunction with the accompanying drawings.

FIG. 1 is a block diagram illustrating one embodiment of a computer system having an operating system that facilitates access control to objects, according to the present invention.

FIG. 2 is a block diagram illustrating a computing object with an improved security descriptor, and explains how the components interact, according to the present invention.

FIG. 3 is a block diagram which further defines FIG. 2 by illustrating a managed access control entry and how it is related to an algorithm in an instruction control entry, according to the present invention.

FIG. 4 is a flowchart illustrating program steps which are processed when an object changes, according to the present invention.

FIG. 5 is a table showing program steps which are processed when an algorithm changes, according to the present invention.

FIG. 6 and FIG. 7 further are exemplary user interface screens illustrating an administration tool for defining and granting access rights to objects within the computing system, according to the present invention.

FIG. 8 is a block diagram depicting a computer system, which is a processing circuit as used by an exemplary embodiment of the present invention, according to the present invention.

FIG. 9 is a block diagram showing exemplified further embodiments of instruction control entries, according to the present invention.

FIG. 10 is a block diagram illustrating another preferred embodiment of a database having a database management system that facilitates access control to records, and explains how the components interact, according to the present invention.

FIG. 11 is a block diagram of a de-serialized and a serialized version of a security descriptor and shows how access control entries relate, according to the present invention.

FIG. 12 is a block diagram showing an improved security descriptor for a database table and explains how it interacts with serialized security descriptors of records.

FIG. 13 is a block diagram showing an improved security descriptor, illustrating how instruction control entries are related to managed access control entries.

### DESCRIPTION OF THE PREFERRED EMBODIMENTS

The present invention overcomes the problems with the prior art by providing an improved security descriptor that stores executable information or refers to executable information, and a method on how access control entries are dynamically created, modified or deleted when attributes of an object change.

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

The terms used and techniques shown in these teachings mainly refer to the Microsoft Windows operating system. It is important to note that the present invention is not limited to these examples. Moreover, those of ordinary skill in the art will appreciate that other operating systems are within the true scope and spirit of the present invention using different or similar terms and techniques.

References Incorporated in this Patent

The following references are each hereby incorporated by reference in there entirety.

U.S. Pat. No. 6,708,276 issued on Mar. 2004 with inventor(s) Yarsa et al. and assigned to International Business Machines Corporation, Armonk, N.Y. (US).

U.S. Pat. No. 6,405,202 issued on Jun. 2002 with inventor(s) and assigned to Britton et al. Trident Systems, Inc., Fairfax, Va. (US).

U.S. Pat. No. 6,823,338 issued on Nov. 2004 with inventor(s) Byrne et al. and assigned to International Business Machines Corporation, Armonk, N.Y. (US).

U.S. Pat. No. 6,810,400 issued on Oct. 2004 with inventor(s) KagalWala et al. and assigned to Microsoft Corporation, Redmond, Wash. (US).

U.S. Pat. No. 6,236,996 issued on May 2001 with inventor(s) Bapat et al. and assigned to Sun Microsystems, Inc., Mountain View, Calif. (US).

U.S. Pat. No. 6,847,995 issued on Jan. 2005 with inventor(s) Hubbard et al. and assigned to United Devices, Inc., Austin, Tex. (US).

U.S. Pat. No. 6,519,700 issued on Feb. 2003 with inventor(s) Ram et al. and assigned to Contentguard Holdings, Inc., Wilmington, Del. (US).

U.S. Pat. No. 6,763,464 issued on Jul 2004 with inventor(s) Wang et al. and assigned to Contentguard Holdings, Inc., Wilmington, Del. (US).

U.S. Pat. No. 6,233,576 issued on May 2001 Lewis and assigned to International Business Machines Corporation, Armonk, N.Y. (US).

U.S. Pat. No. 6,202,066 issued on Mar. 2001 Barkley et al. and assigned to The United States of America as represented by the Secretary of Commerce, Wash., DC (US).

U.S. Pat. No. 5,787,427 issued on Jul. 1998 Benatar et al. and assigned to International Business Machines Corporation, Armonk, N.Y. (US).

U.S. Pat. No. 6,470,339 issued on Oct. 2002 Karp et al. and assigned to Hewlett-Packard Company, Palo Alto, Calif. (US).

U.S. Pat. No. 6,625,603 issued on Sep. 2003 Garg et al. and assigned to Microsoft Corporation, Redmond, Wash. (US).

U.S. Pat. No. 6,412,070 issued on Jun. 2002 Van Dyke et al. and assigned to Microsoft Corporation, Redmond, Wash. (US).

U.S. Pat. No. 6,446,077 issued on Sep. 2002 Straube et al. and assigned to Microsoft Corporation, Redmond, Wash. (US).

U.S. Pat. No. 6,535,879 published on Mar. 2003 Behera and assigned to Netscape Communications Corporation, Mountain View, Calif. (US).

U.S. Pat. No. 6,948,070 published on Mar. 2003 Ginter et al. and assigned to Intertrust Technologies Corporation, Sunnyvale, Calif. (US).

U.S. Pat. No. 5,276,901 published on Jan. 1994 Howell et al. and assigned to International Business Machines Corporation, Armonk, N.Y. (US).

U.S. Pat. No. 6,631,371 published on Jul. 2003 Lei et al. and assigned to Oracle international Corporation, Redwood Shores, Calif. (US).

U.S. Patent Application publication number 20020002557 published on Jan. 2002.

U.S. Patent Application publication number 20020026592 published on Feb. 2002.

U.S. Patent Application publication number 20040083367 published on Apr. 2004.

U.S. Patent Application publication number 20050091518 published on Apr. 2005

Japanese Pat. No. JP20020259190 published on Jun. 10, 2004.

PCT Pat. No. WO 00/51288 published Aug. 31, 2000 and assigned to Siemens AG, Munich, Germany.

An article from Microsoft Corporation, “Enabling Information Protection in Microsoft Office 2003 with Rights Management Services and Information Rights Management”, Microsoft Office 2003, Technical White Paper, Published Dec. 1, 2003. Technical Articles from Microsoft Corporation, “Rights Management Services SDK”, last updated Dec. 2005, (available on line at

http://www.microsoft.com/technet/prodtechnol/windowsserver2003/library/TechRef/addc 004e-a1ad-4fba-8caa-1c9c3eb0fa86.mspx; http://msdn.microsoft.com/library/en-us/ rms_sdk/rm/about_rights_management_services_sdk.asp?frame=true;

http://msdn.microsoft.com/library/en-us/ rms_sdk/rm/interpreting_xrml_rights.asp?frame=true and

http://msdn.microsoft.com/library/en-us/rms_sdk/rm/rms_functions.asp?frame=true).

An article from Stanford University, “Overview of Active Directory Security”, (viewed on Feb. 23, 2005 on line at

http://windows.stanford.edu/Public/Security/ADSecurityOverview.htm).

An article from University of Ky., Canterbury, UK, “PERMIS: Privilege and Role Management Infrastructure Standards Validation” and “OpenPERMIS” open-source project, (viewed on Mar. 3, 2006 on line at http://sec.isi.salford.ac.uk/permis/).

An article from Oracle International Corporation, “Fine Grained Access Control and Application Contexts”, (viewed on Mar. 18, 2006 on line at

http://asktom .oracle.com/%7Etkyte/article2/index.html)

An article from SuSE Linux AG Nuremberg, Germany, “POSIX Access Control Lists on Linux”, (viewed on Feb. 1, 2006 on line at

http://www.suse.de/˜agruen/acl/linux-acls/online/)

Overview of Computinq Objects and Associated Security Information

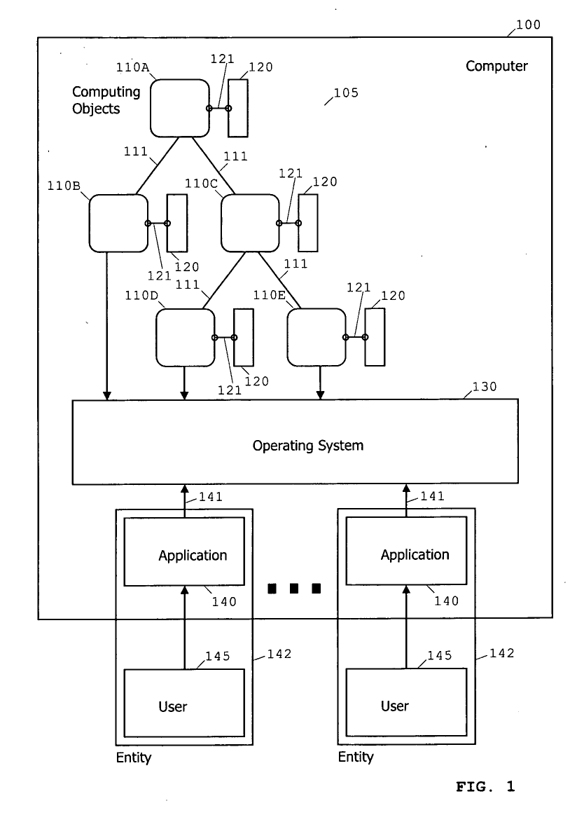

FIG. 1 illustrates a computer 100 in which an operating system 130 controls access to computing objects 110A through 110E (110), which are arranged in an object tree 105. It is important to note, that while an operating system is shown, other instances that control access to computing objects, herein referred to as access control managers, such as for example database management systems (also referred to as DBMS), database engines, file systems, file servers, rights management services, rights management servers, or security managers may also be used. Computing objects 110 represent unique system resources such as servers, computers, printers, email gateways, domains and even system events, or abstract collections of data such as stored data files, registry keys, Active Directory objects and even tables, records or other database objects used by the operating system 130. While a tree is shown, other structures may also be used, as the relationship between objects can take many different forms, for instance the relationship of tables, rows or records in a relational database structure, or the relationship of elements in an Extensible Markup Language file, also referred to as XML. U.S. Pat. No. 6,236,996 describes a system and method for restricting database access, which is hereby incorporated by reference in its entirety. Additionally, computing objects 110 represent objects defined by applications 140 which represent computational entities 142, such as user applications, device drivers, mail handlers, services and proxy servers that are executing on behalf of a corresponding user 145. The entity 142 that creates an object 110 is called the owner and receives permissions to grant or deny further access permissions to other entities, including but not limited to users or user groups. Each application 140 issues an access request 141 to operating system 130 when desiring to operate on one of the computing objects 110. Operating system 130 represents any process or service executing on computer 100 that controls access to objects 110.

Often, application 140 issues an access request 141 based on an action taken by corresponding user 145. For example, user 145 may have issued a command to read or write a file. To control these operations, operating system 130 maintains security information for each object 110, wherein in the exemplary embodiment the security information is stored in security descriptor 120. While one-to-one relationships 121 between each object 110 and its security descriptor 120 are shown, other forms of relationships may also be used by the operating system 130, such as one-to-many relationships between objects of a certain type and a security descriptor assigned to each object access type, such as relationships between objects (as in relational databases) or such as relationships between objects and managed object classes which manage security information. Also, security information may be included inside the object itself using an object oriented tree structure, a binary structure or a descriptive structure, such as extensible rights Markup Language, also referred to as XrML, or as Security Descriptor Definition Language, also referred to as SDDL, or as Extensible Markup Language, or similar schemes. Further, security information may be located in a physically separate or remote location reachable only over internal or external networks, for example when using Rights Management Services, also referred to as RMS. Upon receiving access request 141, operating system 130 examines the security information included in the related security descriptor 120 of the requested object 110 and determines whether application 140 and the corresponding user 145 have permissions to carry out the desired operation on the requested object 110. Based on this determination, operating system 130 enforces access request 141.

In this embodiment, object tree 105 includes five representations of objects 110 (110A through 110E). The objects are arranged in parent-child relationships 111, so, in order to describe some of the relationships shown, object 110A has two child objects 110B and 110C, and inversely, object 110A is the parent object of either object 110B or object 110C. Normally, when computing objects 110 are arranged in a tree, part of the security information included in security descriptor 120 is inherited by the respective child objects, when these are created. That way, child objects receive similar or pre-determined access control information from their parent object. Although implementations of current operating systems don't always update inherited access control information in child objects when the parent object's security descriptor changes, U.S. Pat. No. 6,446,077 describes how such access control information may be propagated along the object tree, which is hereby incorporated by reference in its entirety.

Object Associated with Security Descriptor

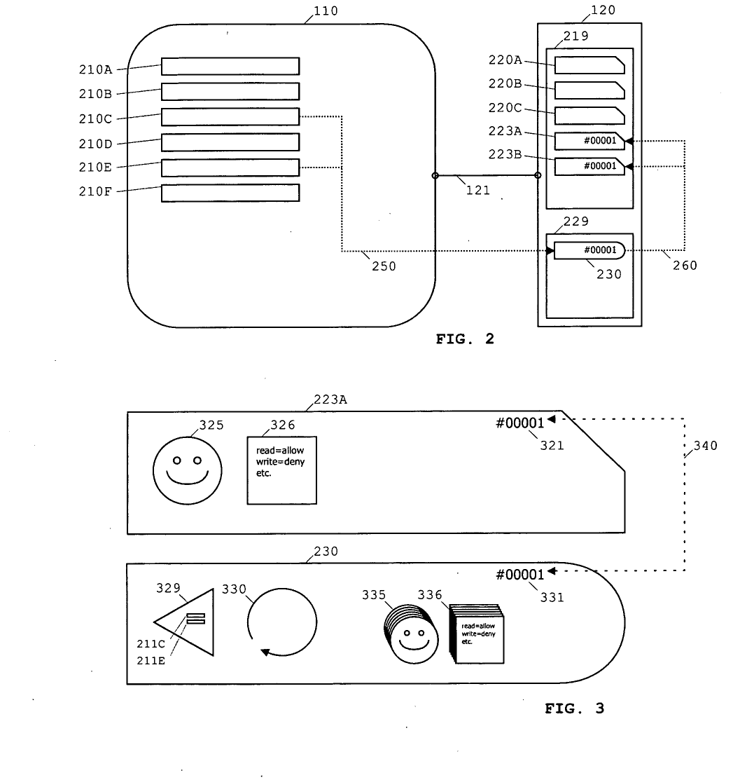

FIG. 2 and FIG. 3 show more specifically, how object 110 is associated 121 with the improved security descriptor 120 that defines corresponding access information. Object 110 accommodates representations of attributes 210 (210A through 210F), sometimes also referred to as properties or fields, which store information coupled with the object. While attributes 210 are shown, other forms of storing information may be used, such as database rows or records which accommodate fields, such as tags attached to or included in a container, or such as XML attributes included in an XML element. For example, a contact object includes attributes such as “Name”, “StreetAddress”, “ZIPCode” or “TelephoneNumber”, which include the corresponding information for that contact object. While the object's attributes 210 are shown as subordinate parts of object 110 that only include values, they can also be considered as separate child objects, each with its own security descriptor assigned, as described in U.S. Pat. No. 6,405,202 which refers to such as “Property Level Security”, which is hereby incorporated by reference in its entirety. While text attributes are shown, attributes 210 may also include more-dimensional data, arrays or collections, as data types can take many different forms. When application 140 issues access request 141, operating system 130 utilizes the security identifiers or similar security access information related to the requesting entity 142 and stored in the access token of the requesting application 140 to match it against information stored in the security descriptor 120 of the requested object 110. Security descriptors for objects include a variety of security information including a plurality of access control lists 219. Each access control list 219 includes a plurality of access control entries 220 and 223, here represented by access control entries 220A through 220C and 223A through 223B, that identify a trusted entity 325 and specify permitted or denied access rights 326 for that trustee. Access control entries 220 and 223 can either be managed, such as access control entries 223, or static, such as access control entries 220. To determine whether to allow application 140 to operate on the requested object 110 as requested in access request 141, operating system 130 examines each access control entry 220 and 223 in the access control list 219 of the security descriptor associated to the requested object 110, until it finds an access control entry 220 and/or 223 where entity 325 corresponds to requesting entity 142. As explained earlier, the algorithm on how access control entries are processed varies widely between operating systems. To those of ordinary skill in the art, it is obvious how managed access control entries have to be deployed to accomplish the desired result. While some access control entries include security information for the current object, others may include inheritable security information that will not come into effect until these access control entries are inherited by child objects. For example, a folder object in a file system may include security information on how the folder can be accessed, plus additional security information that is later inherited by and applied to files stored in that folder or additional security information that is later inherited by and applied to sub-folders of that folder.

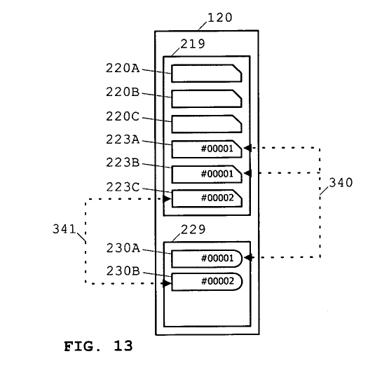

In addition to the security information, the improved security descriptor 120 includes a plurality of instruction control lists 229. Each instruction control list 229 includes a plurality of instruction control entries 230. FIG. 13 is depicting a security descriptor 120 with more than one instruction control entry 230 and shows how managed access control entries 223 are associated by using unique identifiers.

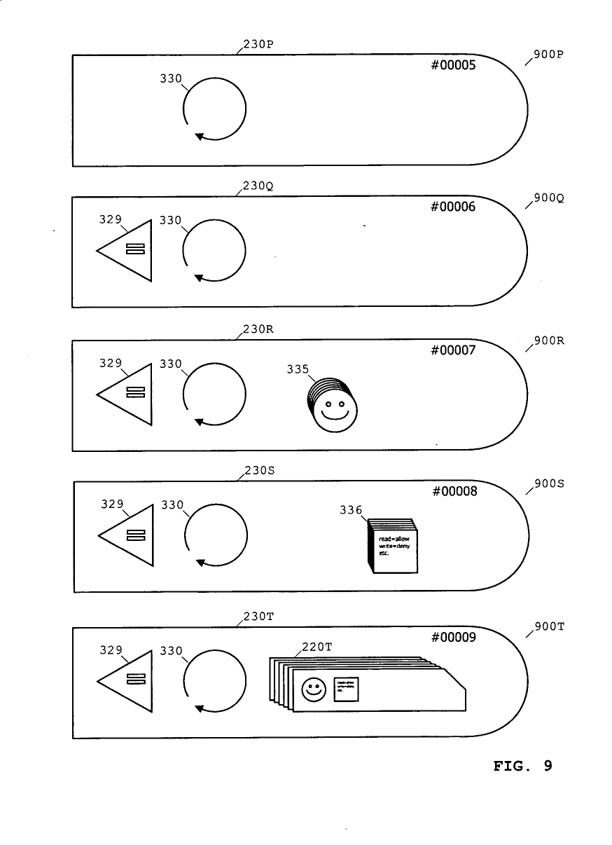

Turning now to FIG. 3, a block diagram is depicted which further defines FIG. 2 by showing a representation of a managed access control entry 223A and how it is related to an algorithm 330 included in an instruction control entry 230. Every instruction control entry 230 includes a list of attributes 329 and an algorithm 330 that consists of executable instructions to create managed access control entries 223 in access control lists 219. While in this embodiment managed access control entries 223 are included in the same security descriptor 120 as the instruction control entry 230 from which they are derived, in another embodiment derived managed access control entries 223 are stored in another security descriptor, such as the security descriptor of the child object. The list of attributes 329 includes any name of those attributes of object 110, which serve as input parameters for algorithm 330. Although the instruction control entry 230 does not necessarily have to include a list of attributes 329, in this embodiment input attributes are cached for improved performance so that instruction control entry 230 does not have to be reprocessed, unless at least one of the input attributes has been modified. Further, the instruction control entry 230 may also include helper objects, such as a pre-set list of entities 335 and/or pre-set lists of access rights 336, which include information that facilitates the algorithm 330 to assemble managed access control entries 223 by copying pre-set entities and/or a pre-set list of access rights to managed access control entries. Also, dependent on the implementation, helper objects 335 and 336 may be exercised separately or in pairs, where a complete access control entry is stored as a single helper object. (FIG. 9 shows some exemplary further embodiments of instruction control entry 230.) Managed access control entries 223 are almost similar to static access control entries 220, except for the difference that they are required to be identifiable, which in this embodiment is achieved by using a unique or global unique identifier 321, also referred to as a GUID or called an object identifier or OID, or by using a uniform resource identifier or URI. Static access control entries 220 are not required to be identifiable.

Algorithm 330 performs calculations based on those attributes 210 of object 110 that are listed in the list of attributes 329, here represented by the attributes 210C and 210E. While referred to an algorithm, other forms of computer executable instructions may also be used, as the implementation of computer executable instructions may take many different forms, such as code, script, rules, directives or policies. Further, while some instruction control entries 230 include dynamic security information for the current object, others may include dynamic security information that will not come into effect until these instruction control entries are transmitted to child objects. Stated differently, instruction control entries 230 can be valid for the current object or be inheritable, in the same manner as access control entries 220. In addition, operating system 130 may employ new types of access rights to allow or deny the creation, modification or deletion of instruction control entries 230.

When attributes 210C and 210E of object 110 are modified and before object 110 is persisted to object tree 105, operating system 130 examines 250 for each instruction control entry 230 included in the assigned security descriptor 120, if the modified attributes are listed in its list of attributes 329. In case at least one of the attributes listed in the list of attributes 329 of instruction control entry 230 have changed, algorithm 330 included in the same instruction control entry 230 is invoked, and related managed access control entries 223 are recalculated 260 before operating system 130 continues persisting the object. In this embodiment, algorithm 330 always creates new access control entries, but before algorithm 330 is invoked, operating system 130 removes obsolete managed access control entries 223 from prior computations that correspond 340 to that algorithm. To identify all corresponding managed access control entries 223, instruction control entry 230, which includes algorithm 330 as well as all corresponding managed access control entries 223, are identified by the same unique or global unique identifiers 321 and 331. Stated differently, managed access control entries 223A through 223B are each tagged with the same unique or global unique identifier 321 as the identifier 331 of the instruction control entry 230 from which they were created. In another embodiment, to keep the position of existing access control entries, it might be favourable to modify or recalculate managed access control entries 223, instead of removing obsolete managed access control entries before creating new ones. Despite the fact that the list of attributes 329 could be omitted without causing detriment and algorithm 330 being invoked every time an object changes, those of ordinary skill in the art understand that this would cause unnecessary workload. Instead, as described in this preferred embodiment, whenever algorithm 330 is created, modified or deleted, or whenever the definition of underlying attributes of object 110 is changed, the list of attributes 329 is generated by uniquely listing the names of all attributes used by algorithm 330. The list of attributes 329 is then stored in instruction control entry 230 along with algorithm 330 to efficiently determine if further processing of related managed access control entries 223 is necessary when object 110 changes. As shown, in this embodiment, list of attributes 329 includes entries 211C and 211E, which each refers and/or points to attributes 210C and 210E of object 110, respectively.

In another embodiment, the process of updating and deleting managed access control entries 223 is left to algorithm 330 instead of having operating system 130 remove obsolete access control entries.

In a further embodiment, algorithm 330 with list of attributes 329 and/or helper objects 335 and 336 are stored outside security descriptor 120 as one or more separate computing objects which are referenced from the instruction control entry by a unique identifier. This outside storage permits these objects to be associated with a plurality of instruction control entries, even though these are inheritable or reside at different locations. The significant advantage of this embodiment is that algorithms or other complex objects are not stored redundantly in many objects, but rather in one single repository. That way, besides less memory being used, the risk of having different versions of the same algorithm in different locations is greatly reduced or avoided. The same result can be achieved by improving object access types, as described in U.S. Pat. Nos. 6,202,066; 5,787,427 and 6,470,339 (which are each individually incorporated by reference in their entirety), by storing improved security descriptors (or sub-ordinary parts of an improved security descriptor, such as for example instruction control lists, instruction control entries or managed access control entries) in objects derived from object access types, instead of assigning security descriptors to each object.

In a further embodiment, for example when implemented into a rights management system such as described in the referenced article “Enabling Information Protection in Microsoft Office 2003 with Rights Management Services and Information Rights Management” and the related Technical Articles, Microsoft Corporation, which is hereby incorporated by reference in its entirety, or as described in U.S. Pat. Nos. 6,763,464; 6,847,995; 6,519,700 or 6,948,070 (which are each individually incorporated by reference in their entirety), algorithm 330 with list of attributes 329 and/or helper objects 335 and 336 are stored on a separate computer or server, such as a rights management server, and are accessed over a network.

Further, in the preferred embodiment, when the object class, also referred to as object definition or object type, is modified and at least one of the attributes 210C and 210E is deleted, operating system 130 from any object of that class also deletes or disables any instruction control entry 230 which refers to that attribute in its list of attributes 329. This in turn causes operating system 130 to delete any related 340 thus obsolete managed access control entry 223. When the object class is modified and at least one of the attributes 210C and 210E is renamed, operating system 130 for objects of that class also changes the name of that attribute in any list of attributes 329 where it occurs, but no further steps are performed.

Flow Chart of Updating Object Permissions

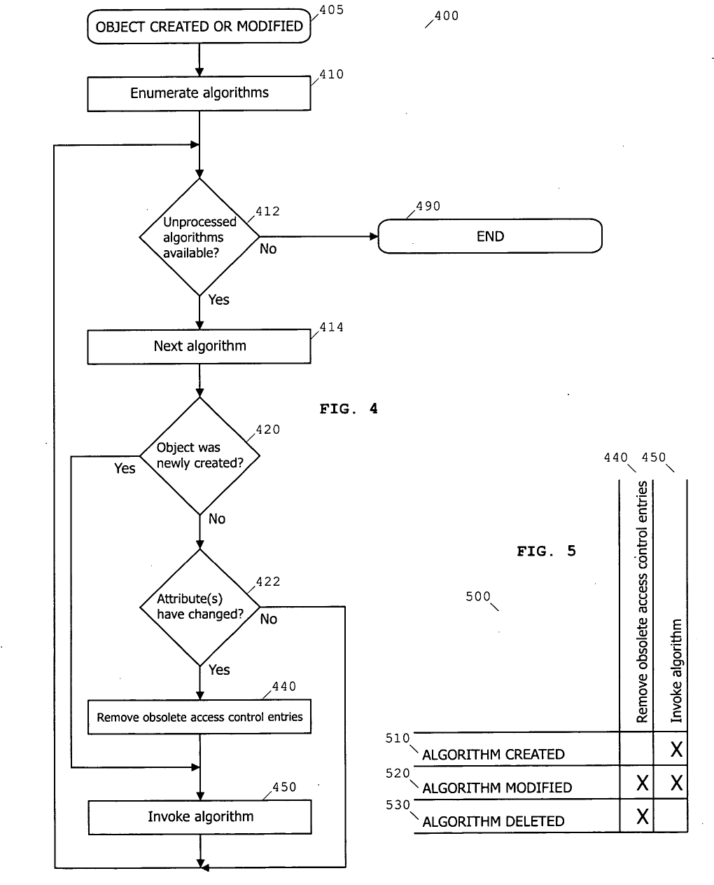

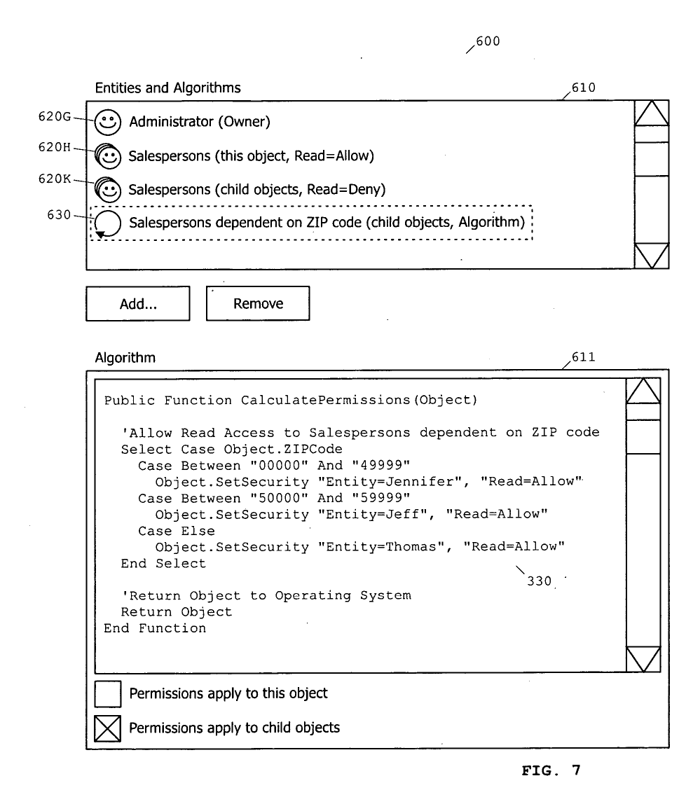

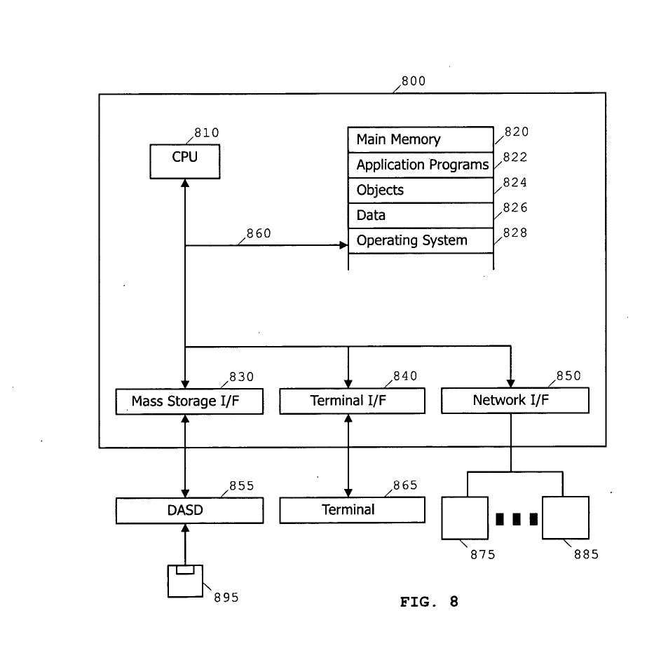

FIG. 4 is a flowchart 400 of one exemplary embodiment of the steps performed after save has been invoked on the object 110, but before the object is persisted to object tree 105. Stated differently, steps are performed, before an insert or update transaction of object 110 is finalized by persisting the new version of object 110 to the data store. For security reasons, and also to receive better performance, in this embodiment the steps described, except for the algorithm itself, are moved to the core of operating system 130. The operating system 130 begins execution with step 405 and immediately proceeds to step 410. In step 410 all algorithms 330 included in the instruction control list 229 are enumerated. More specifically, each of the algorithms associated with the object are carried out one at a time in steps 412 through 450 as follows: If, for example, there are three algorithms, each of the three algorithms would be applied in turn. Thus, in step 412, operating system 130 evaluates whether unprocessed algorithms are available in the enumeration created in step 410. If there are still unprocessed algorithms, the next algorithm is located in step 414 and the operating system proceeds to step 420. In step 420 operating system 130 evaluates if the object was newly created or an existing object was updated. If the object was newly created, the operating system bypasses step 422 and step 440 and immediately proceeds to step 450. If an existing object was updated, it proceeds to step 422 instead. In step 422, by comparing attribute's prior to its current value for each attribute cached in list of attributes 329, operating system 130 evaluates if at least one of the attributes that operate as input for the involved algorithm 330 have changed since last time when object 110 has been persisted to object tree 105. In this embodiment we assume that operating system 130 makes available prior attribute values while the object is being saved. In case an operating system does not provide prior attribute values, these values are cached in the list of attributes 329 together with their attributes' names and the list of attributes 329 is not only updated when the algorithm 330 is changed, but also when an underlying attribute 210C or 210E of object 110 is changed. If there were changes to at least one attribute, operating system 130 proceeds to step 440, if there were no changes, the involved algorithm is skipped and the operating system 130 goes back to step 412 to assess if further unprocessed algorithms exist. In step 440, the operating system 130 locates managed access control entries 223 corresponding to the instruction control entry 230 of the current algorithm 330 and deletes them. It then proceeds to step 450, where algorithm 330 is invoked and new managed access control entries 223 are created in place of the previously deleted ones. Newly created access control entries 223 are then labelled with the same unique or global unique identifier 321 as the unique or global unique identifier 331 included in instruction control entry 230. Note, that the number of corresponding managed access control entries 223 may vary each time algorithm 330 is invoked, dependent on the output of algorithm 330. As explained earlier, algorithm 330 assigns permissions to entities and creates new managed access control entries 223 from their results. The object 110 is not changed by the algorithm 330, but the security descriptor 120 changes when the underlying attributes 210C or 210E are changed. Changes to the attributes 210C and 210E of object 110 trigger changes to the security descriptor 120. An exemplary algorithm is shown in FIG. 7. After processing the current algorithm, the operating system 130 goes back to step 412. Steps 414 through 450 are repeated for each algorithm enumerated in step 410. If in step 412 it is determined that there are no further unprocessed algorithms, flowchart 400 terminates in step 490 and operating system 130 continues storing the object 110. Despite the fact that step 420 through 422 could be omitted without causing detriment, those of ordinary skill in the art understand that it is a general rule not to cause unnecessary workload by invoking an algorithm without need. Furthermore they will appreciate that, dependent on the implementation into a specific operating system, there are many different forms of further optimizations or variations.

In this embodiment, no program steps are performed when an object 110 is deleted, because the operating system 130 also deletes the associated security descriptor 120. In other embodiments, where algorithms 330 or helper objects 335 and 336 are stored outside the security descriptor or where different relationships between object 110 and security descriptor 120 prevail, it may be required to perform additional steps to ensure that no orphaned objects are left behind after an object is deleted.

Table 500 in FIG. 5 shows which program steps from FIG. 4 are performed when an algorithm 330 is created 510, modified 520 or deleted 530. While program step 440 is performed when an existing algorithm 330 is modified 520 or deleted 530, an algorithm is invoked 450 when a new algorithm was created 510 or an existing algorithm was modified 520. In case both program steps are performed, step 440 is performed before step 450. An exemplary algorithm is shown in FIG. 7.

Administrative Tool

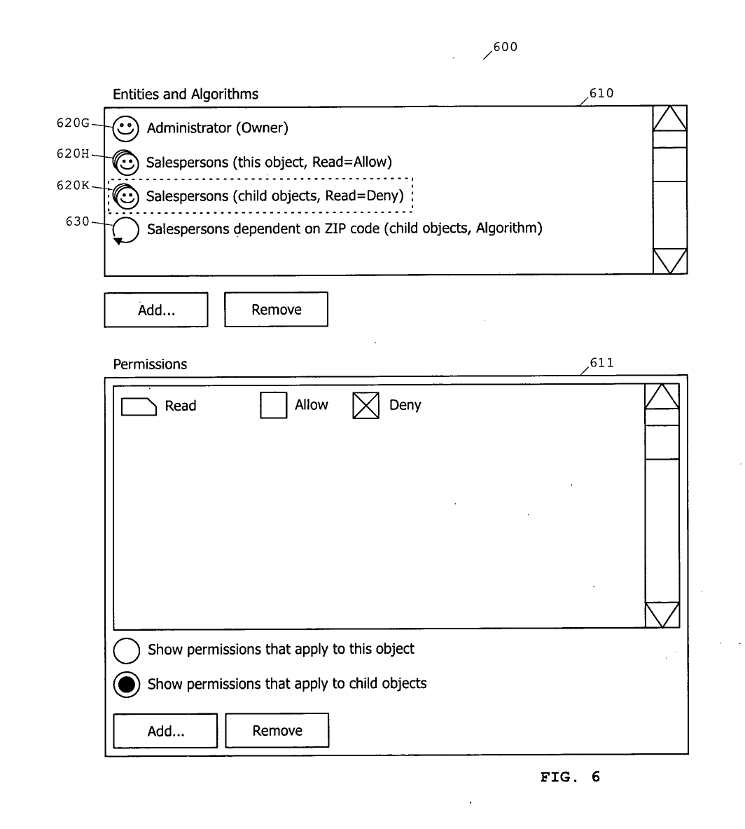

FIG. 6 and FIG. 7 further illustrate one exemplary embodiment of an administration tool 600 to perform the above-described methods and a simplified example of one possible use of this invention. In FIG. 6, an administration tool 600 is shown, that allows users 145 with sufficient permissions to object 110, particularly owners, to view and edit defined access control rights of that object. To manage the security of a particular object 110, administrative tool 600 queries the security descriptor 120 corresponding to object 110 in order to display a list of entities 610 derived from static access control entries 220 and instruction control entries 230 that have been defined for that object 110. List 610 includes two different types of list items 620 and 630. List items 620, here represented by list items 620G, 620H and 620K, are derived from static access control entries 220 that are not related to an instruction control entry 230, whereas the representation of list item 630 corresponds to an instruction control entry 230. When user 145 selects a list item 620, such as list item 620K, form 611 displays a list of all permissions (shown in FIG. 6) according to static access control entries 220 corresponding to the trusted entity 325. In this exemplary embodiment, administration tool 600 does not show permissions derived from managed access control entries 223. In another embodiment, administration tool 600 shows permissions derived from managed access control entries 223 read-only or greyed, as these are created by algorithm 330 and cannot be changed by user 145. Further, when user 145 selects list item 630, form 611 displays algorithm 330 as it is defined in instruction control entry 230, instead (shown in FIG. 7). The exemplified Microsoft Visual Basic pseudo-code shown for algorithm 330 is simplified for demonstration purposes, and those of ordinary skill in the art understand, that this code can be furnished in any programming language available for operating system 130.

To avoid contrary access control entries 220 and 223 resulting from one or more algorithms, from inheritance or from other sources, administration tool 600 in one embodiment performs an integrity check before changes to any access control entry 220 and/or 223 or instruction control entry 230 are committed. Also, operating system 130 must implement rules to be able to handle contrary access control entries 220. As this significantly depends on the type of operating system 130 in which this invention is put into practice the problem of contrary access control entries is not further discussed here. The article “Overview of Active Directory Security”, Stanford University, which is hereby incorporated by reference in its entirety, describes how, for example, Microsoft Windows Active Directory handles contrary access control entries and how administration tool 600 must sort access control entries if it was implemented into an Active Directory environment. U.S. Pat. No. 6,446,077, which is hereby incorporated by reference in its entirety, describes further advanced methods for sorting access control entries resulting from inheritance that are contrary to those associated directly with an object. That same handling, as described there for inherited access control entries, also applies to managed access control entries 223 created by algorithm 330.

In the following example, we assume users “Jennifer”, “Jeff” and “Thomas” have already been assigned to the group “Salespersons” by using operating system 130. For simplicity, we only depict a single access right “Read” and disregard that there may exist a broad variety of additional access rights used by operating system 130 to fine-tune access control, such as “Write”, “List Contents”, “Execute”, “Read & Modify”, “Copy”, “Delete”, “Write Security Descriptor” and others. Further, we suppose operating system 130 supports inheritance and propagates inheritable access control entries 220 and 223 as well as instruction control entries 230 to child objects. Also, we disregard that access control entries 220 and 223 have to be in a specific sort order to be properly evaluated, as required by some operating systems, and instead presuppose that individual permissions have higher priority than group permissions on the operating system 130 where this example is exercised. Although numerous assumptions have been made, it will be appreciated by those of ordinary skill in the art, that there are more arrangements or variations to be considered, depending on the type of operating system where the example is put into practice.

As exemplified in FIG. 6 and FIG. 7, administration tool 600 displays access permissions for a contacts folder object, which includes contact objects as child objects. The contact objects have attributes 210 such as “Name”, “StreetAddress”, “ZIPCode” or “TelephoneNumber”. List entry 620G shows the user “Administrator” as the owner of the contacts folder. The “Administrator” is the trusted entity 325 that can assign permissions to or revoke permissions from other entities or change the algorithm 330. Further, as list entry 620H shows, read access has been granted to the group “Salespersons” on the contacts folder. Next, list entry 620K, which is inherited by the child objects of the contacts folder, specifies that “Salespersons”, by default, are not granted read access to the contacts included in the contacts folder. Because list entries 620G, 620H and 620K are not associated with any instruction control entry 230, they will not be changed dynamically. Finally, list entry 630 applies algorithm 330 to the contacts, which creates managed access control entries 223, dependent on the “ZIPCode” attribute of every contact. In this example only one managed access control entry is created.

When an arbitrary contact object 110 is persisted to object tree 105, steps 405 through 450 of flowchart 400 are performed for this object. In this example, in step 410 one algorithm 330, as shown in form 611 of FIG. 7 is enumerated. Then, in step 420 operating system 130 determines if the contact object has been newly created. Here, we assume it already existed and therefore operating system 130 proceeds with step 422, where the list of attributes 429 is consulted and the contact object's prior “ZIPCode” is compared to the new “ZIPCode”. The attribute “ZIPCode” has previously been listed in the list of attributes 429, because “Object.ZIPCode” is an underlying attribute of algorithm 330, as shown in FIG. 7, form 611. We further assume, the “ZIPCode” has been changed, so that operating system 130 continues with step 440, where obsolete managed access control entries 223 are removed from instruction control list 229. Finally, in step 450, algorithm 330 is invoked.

Algorithm 330 retrieves the “ZIPCode” attribute of object 110 and evaluates it. As illustrated in form 611, and as the exemplary code for algorithm 330 shows, when “ZIPCode” of contact object 110 is between “00000” and “49999”, entity “Jennifer” receives read access on that object; when it is between “50000” and “59999”, “Jeff” is granted read access; in all other cases “Thomas” obtains read access. As a result, any salesperson is only granted read access to those contacts that are in his or her “ZIPCode” area. So when the contact relocates to another area and the address of contact object 110 is updated with a new “ZIPCode”, permissions to access that contact object are dynamically changed. In this example we assume the new “ZIPCode” was set to 33160, which results in a new managed access control entry allowing “Read” access to entity “Jennifer”. Further, when a salesperson changes or a salesperson receives another area, algorithm 330 is edited, which in turn triggers computation of the security descriptor of any contact according to FIG. 5.

Exemplified Further Embodiments of Instruction Control Entries

FIG. 9 is a block diagram showing further embodiments of instruction control entry 230, represented by instruction control entries 230P through 230T. In one embodiment 900P, instruction control entry 230P only includes an algorithm 330, whereas in other embodiments 900Q, 900R and 900S, instruction control entries 230Q, 230R and 230S, respectively, include an algorithm 330, plus any combination of a list of attributes 229, a pre-set list of entities 335 or a pre-set list of access rights 336. In one further embodiment 900T, instruction control entry 230T, besides an algorithm 330 and a list of attributes 229, also includes a plurality of pre-set access control entries 220T. In that embodiment, when algorithm 330 is invoked, a plurality of these pre-set access control entries 220T are selected, labeled with the same unique or global unique identifier of instruction control entry 230T, and then copied to access control list 219. It will be understood by those of ordinary skill in the art that those embodiments shown in FIG. 9 are only some of the forms instruction control entries can take, and that further implementations can be furnished without departing from the spirit and scope of this invention.

Overview of Database System

For brevity, the following description omits some of the details described earlier in “Overview of Computing Objects And Associated Security Information”, “Object Associated with Security Descriptor”, “Flow Chart Of Updating Object Permissions” and “Administrative Tool”. Those of ordinary skill in the art will recognize how to advantageously apply those details here.

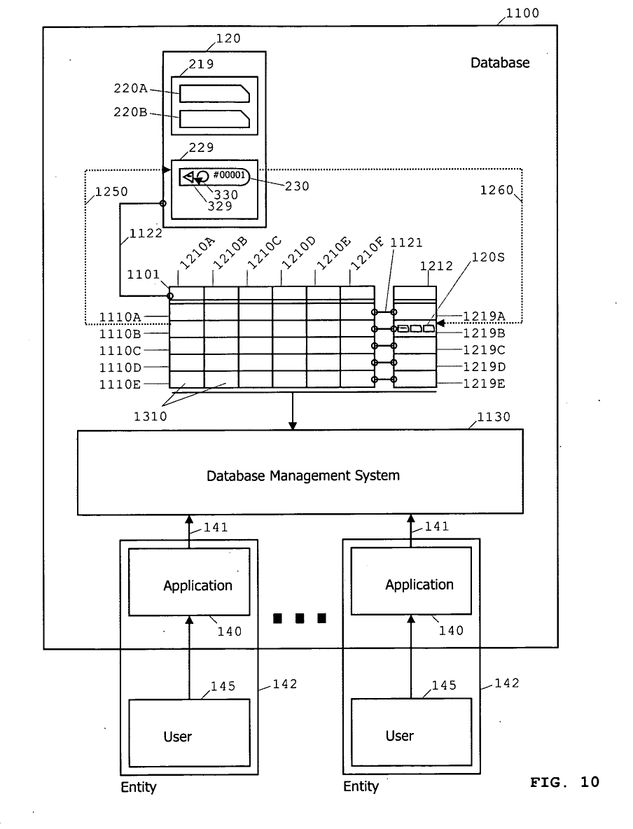

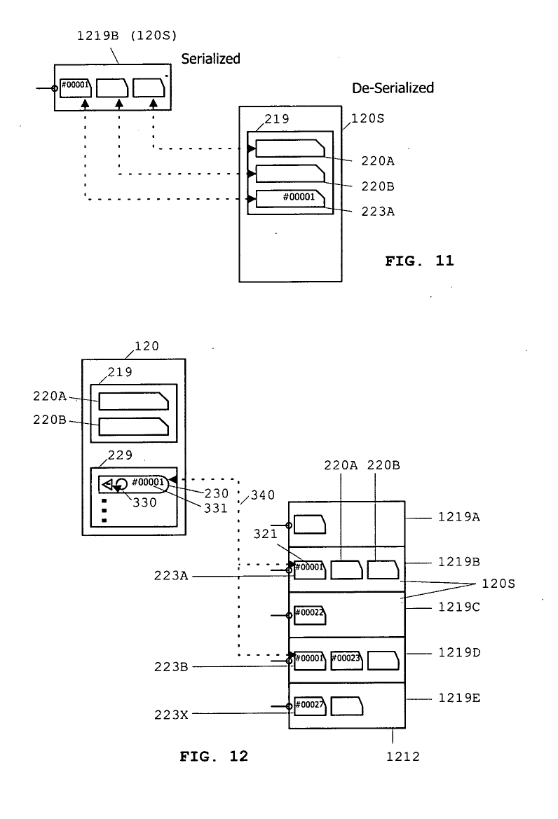

FIG. 10 through 12 illustrate another preferred embodiment of a database 1100 in which a database management system 1130 controls access to database table 1101, which is either unrelated or related to other tables (not shown). While a database management system is shown, other access control managers which control access to database objects may also be used, such as for example a database engine or a database security manager. As shown in FIG. 10, database table 1101 includes a plurality of records 1110A through 1110E, also referred to as database rows, and each record includes a plurality of fields 1310, according to columns 1210A through 1210F as defined in the definition of database table 1101. Further, database table 1101 is assigned 1122 a security descriptor 120, which includes security objects, such as an access control list 219 with a plurality of access control entries 220, here represented by access control entry 220A through 220B, and an instruction control list 229 with a plurality of instruction control entries, here represented by instruction control entry 230. As shown in the first preferred embodiment, instruction control entry 230 includes at least one algorithm 330 and optionally a list of attributes 329 and further helper objects. Because of the fact, that in this embodiment data included in fields 1310 is used as input for algorithm 330, the list of attributes 329 in this embodiment includes a list of names of columns instead of names of attributes. In this embodiment, security descriptor 120 is implemented together with the definition of the database table columns, in another embodiment, security descriptor 120 is implemented as a plurality of system database tables, or as a separate computing object besides database relationships, constraints or other database objects. In addition to security descriptor 120, which stores security information for database table 1101 as well as inheritable security information which will later be inherited by records 1110A through 1110E, table 1101 includes an additional binary table column 1212, which stores security information included in serialized security descriptors 1219A through 1219E (120S), each corresponding 1121 to a record 1110A through 1110E. While a serialized security descriptor in binary format is shown, those of ordinary skill in the art understand, that security information can be stored in many different forms and formats, such as for example, as a descriptive structure in a text field, eXtensible rights Markup Language (XrML), Security Descriptor Definition Language (SDDL) or as an Extensible Markup Language (XML) string. Further, while an additional table column is shown, security information related to records can be stored in many different forms, such as for example in a separate system database table, which itself links to table 1101 by using a unique key and a database relationship. Because security information related to records in this embodiment is stored in an additional column 1212, database management system 1130 always assures that computational entity 142 cannot access column 1212 by directly querying it. In contrary to the first preferred embodiment, where an object tree 105 with a plurality of parent-child generations is shown, in this embodiment there is only one parent-child generation between database table 1101 (which represents a parent container object), and therein contained records 1110A through 1110E (which each represent a child object of table 1101). Further, while security descriptor 120 of database table 1101 includes instruction control entries 230, in this embodiment managed access control entries 223, here represented by managed access control entry 223A as shown in FIG. 12, are stored in the security descriptor of each record 120S, which does not include instruction control entries. Stated differently, under assistance of database management system 1130, algorithm 330 receives its input 1250 from each record 1110A through 1110E and outputs 1260 managed access control entries 223 to security descriptors 1219A through 1219E. As shown in FIG. 12, each instruction control entry 230 stored in security descriptor 120 refers to a plurality of managed access control entries 223 in a plurality of security descriptors 120S.

Each application 140 issues an access request 141 to database management system 1130 when desiring to query at least one record 1110A through 1110E of database table 1101. Often, application 140 issues an access request 141 for computational entity 142 based on an action taken by corresponding user 145. For example, user 145 may have issued a command to select, update or delete records 1110A through 1110E. To control those operations, database management system 1130 maintains security information for each record 1110A through 1110E in security descriptors 1219A through 1219E, respectively, included in the additional table column 1212. Or, user 145 may have issued a command to insert a plurality of records into table 1101. To control that operation, database management system 1130 maintains security information for each database table 1101 in the associated security descriptor 120. Stated differently, when an existing record is accessed, security information related to that record is retrieved to decide if that operation can be carried out. In contrary, when new records are created, security information related to the table in which the new records are created is evaluated, instead. Upon receiving access request 141, database management system 1130 examines the related security information and determines whether application 140 and the corresponding user 145 have permissions to carry out the desired operation on the requested object. Based on this determination, database management system 1130 enforces access request 141.

When application 140 issues access request 141, operating system 130 utilizes the security identifiers or similar security access information related to the requesting computational entity 142 and stored in the access token of the requesting application 140 to match it against security information stored in either security descriptor 120 or security descriptors 1219A through 1219E (120S), dependent on the type of access request 141 issued. As shown in FIG. 10 through 12, security descriptors 120 and 120S include a variety of security information including a plurality of access control lists 219, where each access control list 219 includes a plurality of access control entries 220 and 223 that each identify a trusted entity and specify permitted or denied access rights for that trustee. Access control entries 220 and 223 can either be static 220 or managed 223 as explained in the first preferred embodiment of this invention. To determine whether to allow application 140 to operate on the requested table 1101 or on the requested records 1110A through 1110E as requested in access request 141, database management system 1130 examines each access control entry 220 and 223 in access control list 219 of security descriptor 120/120S according to the requested table or record, until it finds an access control entry 220 and/or 223 where entity 325 (shown in FIG. 3) corresponds to requesting entity 142. In addition, the improved security descriptor 120 includes a plurality of instruction control lists 229, where each instruction control list 229 includes a plurality of instruction control entries 230. While in this embodiment, serialized security descriptors 120S are de-serialized to determine if an access request is granted or denied, in another embodiment same is achieved by serializing the access token and comparing both serializations or by performing calculations on these serializations. While in this embodiment the serialized security descriptor 120S includes access control entries 220 and 223 directly and does not include an instruction control list 229, in another embodiment security descriptor 120S includes a plurality of instruction control lists 229 and a plurality of access control lists 219, which each include a plurality of instruction control entries 230 and a plurality of access control entries 220 and 223, respectively. Those of ordinary skill in the art understand, that in this embodiment faster processing of security operations was achieved by reducing the complexity of security descriptors 120S, but on the other hand will appreciate that such reduction also impedes flexibility in terms of managing access control.

Turning now back to our example of the salespersons “Jeff”, “Jennifer” and “Thomas”. With the same assumptions we made before, in this embodiment user 145 issues an insert command to insert records with customer data into table 1101. Before database management system 1130 commits the insert statement, by using security descriptor 120 (which is associated 1122 with table 1101) it evaluates if user 145 has sufficient access rights to insert records into table 1101, which we assume in this example to be true. When each record is inserted, database management system 1130 creates a new security descriptor 1219A through 1219E (120S), serializes it, stores it in the binary field of column 1212 and inserts it into table 1101 together with the new record. While in this embodiment column 1212 is inserted at the same time when the record is inserted, in another embodiment database management system 1130 leaves column 1212 blank and issues an after insert trigger for each record inserted which creates security descriptor 120S and updates column 1212 thereafter. After database management system 1130 creates security descriptor 120S, it copies inheritable access control entries 220A through 220B from security descriptor 120 to the newly created security descriptor 120S. In another embodiment, instead of copying inheritable access control entries, database management system places links into security descriptor 120S which refer to the access control entries included in security descriptor 120. Then, according to the flowchart shown in FIG. 4, database management system 1130 enumerates any instruction control entry 230 included in instruction control list 229 of security descriptor 120, and invokes any algorithm 330 included in each instruction control entry 230. As algorithms 330 create 1260 managed access control entries 223, these are also inserted into security descriptor 120S, before it is serialized and persisted. As shown in FIG. 3 and FIG. 12, managed access control entries 223 are linked 340 and 341 by unique or global unique identifiers 321 and 331 to that instruction control entry 230 which created it. In this example, because the “ZIPCode” field is listed in the list of attributes 329 of security descriptor 120, algorithm 330 creates managed access control entries 223 which for each record give “Read” access to “Jeff”, “Jennifer” or “Thomas” according to the ZIP Code of that record. For simplicity, we only depict a single access right “Read” and disregard that there may exist a broad variety of additional access rights used by database management system 1130 to fine-tune access control, such as “Allow Select”, “Allow Update”, “Allow Insert”, “Deny Delete”, “Change Table Definition” and others.

Now, every time a computational entity 142 selects, updates or deletes a plurality of records included in table 1101, database management system 1130 assesses security descriptor 120S of each record to evaluate for that record if the requested operation can be performed on that record, and then filters the records so that those records for which entity 142 does not have appropriate access rights are excluded from the recordset on which the requested operation is performed. In this embodiment, records are filtered after all requested records have been retrieved from the table, but before they are either returned to the requesting entity, modified or deleted. In another embodiment, records are masked according to the access rights of entity 142 while still in the table, so that the requested operation is only performed on those records remaining unmasked. In this embodiment, when records are requested from more than one table at a time, such as for example by using a view or a join, all records in disregard of their access rights are joined and retrieved as a temporary recordset, and only those records are kept in the resulting recordset, for which requesting entity 142 has appropriate access permissions for each and any security descriptor included in each joined row of that recordset. In another embodiment, records of all tables requested in the join are masked according to the access rights of entity 142 before the join is executed, and only those records remaining unmasked are further processed. In either case, fields including security descriptors are stripped from recordsets before these are returned or modified, so raw security data is never returned or exposed to the requesting entity.

In addition to above teachings showing how an insert operation is executed, when the requested operation is an update operation, security descriptors 120S of each record, as it is included in the recordset used for that update, are each recalculated according to the flowchart shown in FIG. 4. Further, when an algorithm 330 included in security descriptor 120 of a table 1101 is created, modified or deleted, security descriptors 120S of all records in that table are recalculated according to the table depicted in FIG. 5. While in this embodiment security descriptors 120S are recalculated by removing and re-creating managed access control entries 223, in another embodiment security descriptors 120S are recalculated by correcting already existing managed access control entries 223, instead of removing and re-creating them.

Algorithm 330 performs calculations based on those fields 1210A and 1210F of table 1101 that are listed in the list of attributes 329 of security descriptor 120. While referred to an algorithm, other forms of instructions executable in a database may also be used, as the implementation of computer executable instructions may take different forms, such as code, script, rules, directives, policies, triggers, stored procedures or structured query language, also referred to as SQL. In addition, database management system 1130 may employ new types of access rights to allow or deny the creation, modification or deletion of instruction control entries 230, or new SQL commands to create, modify or delete static access control entries 220 or instruction control entries 230.

When fields 1210A through 1210F of a record 1110A through 1110E are modified, database management system 1130 inspects 1250 each instruction control entry 230 included in the assigned security descriptor 120, to evaluate if the modified fields are listed in its list of attributes 329. If at least one of the fields listed in the list of attributes 329 has changed, algorithm 330 included in the same instruction control entry 230 is invoked, and related managed access control entries 223 are recalculated 1260 before database management system 1130 continues persisting the record. In this embodiment, algorithm 330 always creates new access control entries, but before algorithm 330 is invoked, database management system 1130 removes obsolete managed access control entries 223 from prior computations that correspond 340 to that algorithm. To identify all associated managed access control entries 223, the instruction control entry 230 that includes algorithm 330 as well as all corresponding managed access control entries 223 are identified by the same unique or global unique identifiers 321 and 331. Stated differently, managed access control entries 223 are tagged with the same unique or global unique identifier 321 as the identifier 331 of that instruction control entry 230 from which they are derived. Despite the fact that the list of attributes 329 could be omitted without causing detriment and algorithm 330 being invoked every time a record changes, those of ordinary skill in the art understand, that this would cause unnecessary workload. Instead, as described in this embodiment, whenever algorithm 330 is created, modified or deleted, or whenever the definition of underlying table columns 1210A through 1210F is changed, the list of attributes 329 is generated by uniquely listing the names of all attributes used by algorithm 330. The list of attributes 329 is then stored in instruction control entry 230 along with algorithm 330 to efficiently determine if further processing of related managed access control entries 223 is necessary when a record 1110A through 1110E changes.

Further, when table 1101 is redesigned and the definition of table columns is changed, and any table column 1210A through 1210F is deleted, database management system 1130 also deletes or disables any instruction control entry 230 which refers to that column in its list of attributes 329. This in turn triggers recalculation of any security descriptor 120S that includes at least one managed access control entry 223 related to the deleted or disabled instruction control entry 230, so obsolete managed access control entries 223 are removed. When a table column 1210A through 1210F is renamed, the name change is reflected in the list of attributes 329 and algorithm 330 of any instruction control entry 230 which refers to that column, but no further recalculations of security descriptors 120S are performed.

FIG. 11, a block diagram which further defines FIG. 10, is showing a serialized version 1219B and a de-serialized version of the same security descriptor 120S. While the depicted de-serialized version includes an access control list 219, which itself includes static access control entries 220A through 220B (in this embodiment inherited from security descriptor 120) and a managed access control entry 223A, in this embodiment the serialized version itself serves as access control list and directly includes a serialized binary version of all access control entries 220 and 223. As explained in detail in the first embodiment, to a very large extent it depends on the database system where this invention is exercised, in which order access control entries are stored in each version of the security descriptor shown, and if the order matters at all. In this embodiment we assume, the order of access control entries is irrelevant for database management system 1130.

In FIG. 12, a block diagram which further defines FIG. 10, is showing a security descriptor 120 as it is assigned to a database table 1101, and how it is related 340 to security descriptors 120S as they are assigned to records 1110A through 1110E and stored in a designated table column 1212. The improved security descriptor 120 in this embodiment includes a plurality of access control lists 219 and a plurality of instruction control lists 229. Access control lists 219 each include a plurality of static access control entries 220A through 220B, which are either used to define access rights for operations on database table 1101, such as for example when an insert command is issued to insert new records into table 1101, or which are used to be inherited by newly created records for later defining access rights for operations on records 1110A through 1110E stored in that table. Instruction control lists 229 each include a plurality of instruction control entries 230 which each include at least an algorithm 330. In addition, every instruction control entry 230 is identified by a unique or global unique identifier 331.

The security descriptors 1219A through 1219E (120S) each include a plurality of access control entries 220 and 223, where access control entries can either be static, as for example access control entries 220A through 220B (220), or managed, as for example access control entries 223A through 223B, and 223X (223). While managed access control entries 223 are identified by a unique or global unique identifier 321, static access control entries 220 carry no such identifier. While managed access control entries 223A through 223B are related 340 to the depicted instruction control entry 230, other managed access control entries, such as 223X are related to other instruction control entries not depicted in the drawing. While newly created instruction control entries 230 receive a new unique identifier, managed access control entries 223 receive a copy of the same identifier included in the instruction control entry 230 from which they are derived when algorithm 330 included in that instruction control entry 230 is invoked.

FIG. 13 is depicting an improved security descriptor 120 which includes more than one instruction control entries 230A through 230B (230) included in instruction control list 229 and shows how managed access control entries 223A through 223C (223) included in access control list 219 are each associated 340 and 341 to one instruction control entry 230 by using unique or global unique identifiers. While managed access control entries 223A and 223B are derived 340 from instruction control entry 230A, managed access control entry 223C is derived 341 from instruction control entry 230B. The static access control entries 220A through 220C, which are also included in access control list 219, are not identified by a unique identifier.

Software and Computer Program Medium

A block diagram depicting a computer system 800, which is a processing circuit as used by an exemplary embodiment of the present invention is illustrated in FIG. 8. Processing circuits as understood in this specification include a broad range of processors, including any variety of processing circuit or computer system that is located at a single location, or distributed over several identifiable processors. These several processors are further able to be collocated or physically dispersed within a local area or a geographically widespread area. Any suitably configured processing system is also able to be used by embodiments of the present invention. The computer system 800 has a processor 810 that is connected to a main memory 820, mass storage interface 830, terminal interface 840 and network interface 850. A system bus 860 interconnects these system components. Mass storage interface 830 is used to connect mass storage devices, such as DASD device 855, to the computer system 800. One specific type of DASD device is a floppy disk drive, which may be used to store data to and read data from a floppy diskette 895.

Main Memory 820 contains application programs 822, objects 824, data 826 and an operating system image 828. Although illustrated as concurrently resident in main memory 820, it is clear that the applications programs 822, objects 824, data 826 and operating system 828 are not required to be completely resident in the main memory 820 at all times or even at the same time. Computer system 800 utilizes conventional virtual addressing mechanisms to allow programs to behave as if they have access to a large, single storage entity, referred to herein as a computer system memory, instead of access to multiple, smaller storage entities such as main memory 820 and DASD device 855. Note that the term “computer system memory” is used herein to generically refer to the entire virtual memory of computer system 800.

Operating system 828 is a suitable multitasking operating system. Operating system 828 includes a DASD management user interface program to manage access through the mass storage interface 830. Embodiments of the present invention utilize architectures, such as an object oriented framework mechanism, that allows instructions of the components of operating system 828 to be executed on any processor within computer 800.

Although only one CPU 802 is illustrated for computer 802, computer systems with multiple CPUs can be used equally effectively. Embodiments of the present invention incorporate interfaces that each include separate, fully programmed microprocessors that are used to off-load processing from the CPU 802. Terminal interface 808 is used to directly connect one or more terminals 818 to computer system 800. These terminals 818, which are able to be non-intelligent or fully programmable workstations, are used to allow system administrators and users to communicate with computer system 800.

Network interface 850 is used to connect other computer systems or group members, e.g., Station A 875 and Station B 885, to computer system 800. The present invention works with any data communications connections including present day analog and /or digital techniques or via a future networking mechanism.

Although the exemplary embodiments of the present invention are described in the context of a fully functional computer system, those skilled in the art will appreciate that embodiments are capable of being distributed as a program product via floppy disk, e.g. floppy disk 895, CD ROM, DVD, or other form of recordable media, or via any type of electronic transmission mechanism.

### Other Embodiments

In another embodiment an algorithm is located outside the core of the operating system or the database management system, for example as an external software application, service or tool, or as an extension to the operating system or database management system, also referred to as add-on, add-in, plug-in, snap-in or as by various other vendor-specific names. This embodiment is preferably exercised, when the operating system or database management system does not provide for managed access permissions. In this embodiment, static access control entries are managed by the external software application, instead. Instruction control entries and references to objects and their security descriptors are also held outside the core of the operating system or database management system, along with cached copies of the object's and/or the security descriptor's last state, such as for example a copy of the last version of the security descriptor's access control entries, the date and time when the object was last modified or attributes'last values. In this embodiment, instead of using unique identifiers, the external software application evaluates which static access control entries have to be managed and recalculated by comparing different versions of cached objects, whenever it has been notified of object changes, for example by using a hook, an event, an event sink, a subscription, or a trigger.

In another embodiment, existing security descriptors are used without modification and instruction control entries or other security information held in a different location is linked to the object or its associated security descriptor by the fully distinguished name (also referred to as FDN), the unique or global unique identifier, or any other unique attribute, of the object or the associated security descriptor.

In another embodiment, existing security descriptors are used without modification and all access control entries or only those access control entries with specific pre-defined properties are removed before an algorithm of an object is invoked to calculate new access control entries, and no unique identifiers are used to identify corresponding access control entries.

In another embodiment, access control entries of a plurality of security descriptors are associated with the same instruction control entry, so that changes to one object trigger modifications to more than one security descriptor at a time.

In another embodiment, algorithms of inherited security descriptors are linked to their parent security descriptor's algorithms so that changes to one algorithm update other algorithms in a cascade.

In another embodiment, access control entries in a child object are linked to their parent access control entry, instead of being copied.

In another embodiment, access control lists, algorithms, instruction control lists, instruction control entries or other objects included therein are stored inside an object, an object's attribute or in an access type or class.

In another embodiment, when using inheritance, access control entries or instruction control entries are only applied after having been inherited down to a specific predefined generation, or inheritance is limited by the minimum and maximum degree of inheritance.

In another embodiment, instruction control entries are stored in the parent object of the object they manage. In that embodiment, often the security descriptor of a container object includes instruction control entries, which manage access control entries of the security descriptor that belongs to the container object's child object, such as for example a folder that manages access permissions of files, or such as a database table that manages access permissions of records.

In another embodiment, instruction control entries are limited to a specific object type or class, and algorithms are only invoked if the object type coincides.

In another embodiment, algorithms, instruction control lists, instruction control entries or other objects included therein are located outside an instruction control entry or outside a security descriptor on the same computer, on another computer, on a server, or on a remote computer and may be invoked and processed over a network.

In another embodiment, only limited flexibility is achieved by using non-executable structures, such as for example rules, instead of algorithms.

In another embodiment, the instruction control list is omitted and a single instruction control entry is stored directly in the security descriptor.

In another embodiment, the instruction control list is omitted and instruction control entries are stored in an improved access control list along with the access control entries they manage.

In another embodiment, to evaluate if the algorithm must be invoked, the algorithm is analyzed for attributes it uses as input, instead of using a cached list of attributes.

In another embodiment, the list of attributes is omitted and the algorithm in invoked whenever an associated object changes, but the previous security descriptor is only replaced, when the newly created security descriptor differs from the previous security descriptor.

In another embodiment, particularly when exercising the invention on a relational database or a database server, a plurality of tables or parts thereof may be used to store algorithms, instruction control lists, instruction control entries, or other objects included therein.

In another embodiment, particularly when exercising the invention on a relational database or a database server, an owner is only assigned to each database table, not to each record of a database table.

In another embodiment, particularly when exercising the invention on an existing relational database or a database server, which is not prepared for handling dynamic permissions, an implementation of managed permissions can be achieved by using a system of views, stored procedures, and triggers to abstract the tables from being viewed, as described in U.S. Pat. No. 6,236,996, which is hereby incorporated by reference in its entirety. Such structure is then extended by instruction control entries, for example by using triggers and a stored procedure, which updates records including security information dependent on their related record's fields.

Non Limiting Hardware and Software Examples

The present invention can be realized in hardware, software, or a combination of hardware and software. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program in the present context means any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system to read data, instructions, messages or message packets, and other computer readable information from the computer readable medium. The computer readable medium may include non-volatile memory, such as ROM, Flash memory, Disk drive memory, CD-ROM, DVD, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer system to read such computer readable information.

Although a specific embodiment of the invention has been disclosed, it will be understood by those of ordinary skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. A method for dynamically managing access permissions for access to a computing object, the method comprising:
creating a plurality of computing objects wherein each computing object represents a unique system resource used by an access control manager through security information associated with the computing object, wherein each computing object includes at least one attribute, and wherein the security information includes at least one instruction control entry for managing access permissions to the computing object; and
associating at least one algorithm with each instruction control entry;
wherein in response to changing at least one attribute of the computing object, the access control manager dynamically changes the security information through use of the algorithm.

2. The method of claim 1, wherein the instruction control entry includes the algorithm and a unique identifier so that in response to updating at least one attribute of the computing object, at least one access control entry is associated to the instruction control entry by the unique identifier.

3. The method of claim 2, wherein the unique identifier is distinct from an identifier associating the computing object and the security information.

4. The method of claim 1, wherein the security information includes static access control entries.

5. The method of claim 1, wherein the instruction control entry is in a list separate from a list of static access control entries.

6. The method of claim 1, wherein the security information is stored inside the computing object.

7. The method of claim 1, wherein the computing object is at least one of a database table and a record, and wherein the attribute is a field.

8. The method of claim 7, wherein the security information is stored in at least one of:
the database table;
a field of the database table column;
a definition of the database table; and
a separate computing object.

9. The method of claim 1, wherein the computing object is at least one of:
a file;
an object;
system resources;
Microsoft Windows Active Directory objects;
Microsoft Exchange Store objects;
Apple Open Directory objects; and
Novell eDirectory objects.
and wherein the security information is formatted using at least one of:
an object oriented tree structure;
a binary structure;
a descriptive structure;
eXtensible rights Markup Language (XrML);
a Security Descriptor Definition Language (SDDL); and
Extensible Markup Language (XML).

10. A method for dynamically managing access permissions for access to a computing object, the method comprising:
creating a plurality of computing objects wherein each computing object represents a unique system resource used by an access control manager, and wherein each computing object includes at least one attribute;
associating at least one first security descriptor with each computing object where each first security descriptor includes at least one static access control entry which determines access permissions to the computing object; and
associating at least one second security descriptor with each computing object where each second security descriptor includes at least one instruction control entry for managing access permissions to the computing object;
associating at least one algorithm with each instruction control entry;
wherein in response to changing at least one attribute of the computing object, the access control manager dynamically changes the first security descriptor through use of the algorithm.

11. The method of claim 10, wherein the second security descriptor includes a copy of at least one static access control entry of the first security descriptor.

12. The method of claim 11, wherein the associating of at least one second security descriptor with each computing object is through one of:
associating the second security descriptor with the first security descriptor; and
associating the second security descriptor with the computing object.

13. The method of claim 11, wherein the second security descriptor is implemented outside a core of an operating system using at least one of:
an external software application;
a service; and
an extension to the operating system.

14. A computer readable storage medium containing programming instructions for dynamically managing access permissions for access to a computing object, the programming instructions comprising:
creating a plurality of computing objects wherein each computing object represents a unique system resource used by an access control manager through security information associated with the computing object, wherein each computing object includes at least one attribute, and wherein the security information includes at least one instruction control entry for managing access permissions to the computing object; and
associating at least one algorithm with each instruction control entry;
wherein in response to changing at least one attribute of the computing object, the access control manager dynamically changes the security information through use of the algorithm.

15. The computer readable storage medium of claim 14, wherein the instruction control entry includes the algorithm and a unique identifier so that in response to updating at least one attribute of the computing object, at least one access control entry is associated to the instruction control entry by the unique identifier.

16. The computer readable storage medium of claim 15, wherein the unique identifier is distinct from an identifier associating the computing object and the security information.

17. The computer readable storage medium of claim 14, wherein the security information includes at least one access control entry.

18. An information processing system comprising:
a plurality of computing objects wherein each computing object represents a unique system resource used by an access control manager through security information associated with the computing object, wherein each computing object includes at least one attribute, and wherein the security information includes at least one instruction control entry for managing access permissions to the computing object; and
at least one algorithm associated with each instruction control entry, wherein the algorithm in response to changing at least one attribute of the computing object, the access control manager dynamically changes the security information through use of the algorithm.

19. The information processing system of claim 18, wherein the instruction control entry includes the algorithm and a unique identifier so that in response to updating at least one attribute of the computing object, at least one access control entry is associated to the instruction control entry by the unique identifier.

20. The information processing system of claim 19, wherein the unique identifier is distinct from an identifier associating the computing object and the security information.

21. The information processing system of claim 18, wherein the security information includes at least one static access control entry.
